(19) United States
(12) Patent Application Publication
(10) Pub. No.: US 2016/0138695 A1
(43) Pub. Date: May 19, 2016

(54) DISCONNECTING AWD DRIVELINE WITH TORQUE-VECTORING CAPABILITIES

(71) Applicant: e-AAM Driveline Systems AB, Trollhättan (SE)

(72) Inventor: Gabriel Trönnberg, Trollhättan (SE)

(21) Appl. No.: 14/546,295

(22) Filed: Nov. 18, 2014

(51) Int. Cl. F16H 48/36; F16H 48/22; F16H 48/08; F16H 48/20; F16H 48/34

(52) U.S. Cl. CPC F16H 48/36; F16H 48/20; F16H 48/34; F16H 48/08; F16H 48/22; F16H 2048/343; F16H 2048/346; F16H 2048/364

(57) ABSTRACT

A driveline component that is configured for use in an all-wheel drive vehicle. The driveline component is a secondary axle that can be disconnected from a primary axle, e.g. for improved fuel economy, or connected to the primary axle so that all four vehicle wheels are driven. Regardless of whether the driveline component is connected to or disconnected from the primary axle, a torque-vectoring module in the driveline component can be operated to create a differential moment that can be applied to the wheels of the secondary axle.

### FIELD

The present disclosure relates to a disconnecting all-wheel drive driveline with torque-vectoring capabilities.

### BACKGROUND

This section provides background information related to the present disclosure which is not necessarily prior art.

U.S. Pat. No. 8,795,126 discloses an all-wheel drive driveline with a means for selectively disconnecting the rear driveline from the vehicle powertrain. This arrangement provides increased fuel economy when the rear driveline is disconnected, and provides improved traction when the rear driveline is connected.

U.S. Pat. No. 8,663,051 discloses an electrically-driven rear drive module for a front wheel drive vehicle. Some examples of the rear drive module can be operated to provide propulsive power, or alternatively to aid in controlling the vehicle using a technique known as torque-vectoring.

We have found that it would be desirable to have a disconnecting driveline component for an all-wheel drive vehicle that has torque-vectoring capabilities.

### SUMMARY

This section provides a general summary of the disclosure, and is not a comprehensive disclosure of its full scope or all of its features.

In one form, the present disclosure provides a driveline component with a housing, an input pinion, a ring gear, a differential assembly, first and second output shafts, a rotary coupling and a torque-vectoring system. The housing defines a cavity. The input pinion is received in the cavity and is rotatable about a first axis. The ring gear is received in the cavity and is rotatably disposed about a second axis. The ring gear is meshingly engaged with the input pinion. The differential assembly has a differential case, a first differential output member and a second differential output member. The first and second output shafts are drivingly coupled to the first and second differential output members, respectively. The rotary coupling has first and second portions that are rotatably disposed about the second axis. The first portion is coupled to the ring gear for common rotation. The second portion is coupled to the differential case for common rotation. The rotary coupling is configured to selectively transmit rotary power between the ring gear and the differential case. The torque-vectoring system has a transmission with a first planetary gearset and a second planetary gearset. The first planetary gearset has a first planetary ring gear, a first planet carrier, a first sun gear and a plurality of first planet gears. The first planetary ring gear is fixedly coupled to the housing. The first planet carrier is rotatably coupled to one of the first output shaft and the second portion of the rotary coupling. The first sun gear is disposed about the first output shaft. The first planet gears are rotatably supported by the first planet carrier and are meshingly engaged with the first planetary ring gear and the first sun gear. The second planetary gearset has a second planetary ring gear, a second planet carrier, a second sun gear and a plurality of second planet gears. The second planetary ring gear is rotatably disposed about the first output shaft. The second planet carrier is rotatably coupled to the other one of the first output shaft and the second portion of the rotary coupling. The second sun gear is disposed about the first output shaft and is coupled to the first sun gear for common rotation about the second axis. The second planet gears are supported for rotation on the second planet carrier and meshingly engaged with the second planetary ring gear and the second sun gear.

In another form, the present disclosure provide a driveline component that includes a housing, an input pinion, a ring gear, a differential assembly, a first axle shaft, a first coupling and a transmission. The input pinion is received in the housing and is rotatable about a first axis. The ring gear is received in the housing and is rotatable about a second axis. The ring gear is meshingly engaged with the input pinion. The differential assembly is received in the housing and is rotatable about the second axis. The differential assembly has a differential case, a first differential output and a second differential output. The first axle shaft is coupled to the first differential output for rotation therewith. The first coupling is configured to selectively couple the differential case to the ring gear for common rotation. The first coupling has a first portion, which is coupled to the ring gear for common rotation, and a second portion that is coupled to the differential case for common rotation. The transmission has first and second planetary gearsets that are selectively operable to apply equal and oppositely directed moments to the second portion of the first coupling and the first axle shaft.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a vehicle having an exemplary driveline component constructed in accordance with the teachings of the present disclosure;

FIG. 2 is an enlarged view of a portion of FIG. 1 illustrating the driveline component in greater detail; and

FIG. 3 is a schematic illustration of a second driveline component constructed in accordance with the teachings of the present disclosure.

Corresponding reference numerals indicate corresponding parts throughout the several views of the drawings.

### DETAILED DESCRIPTION

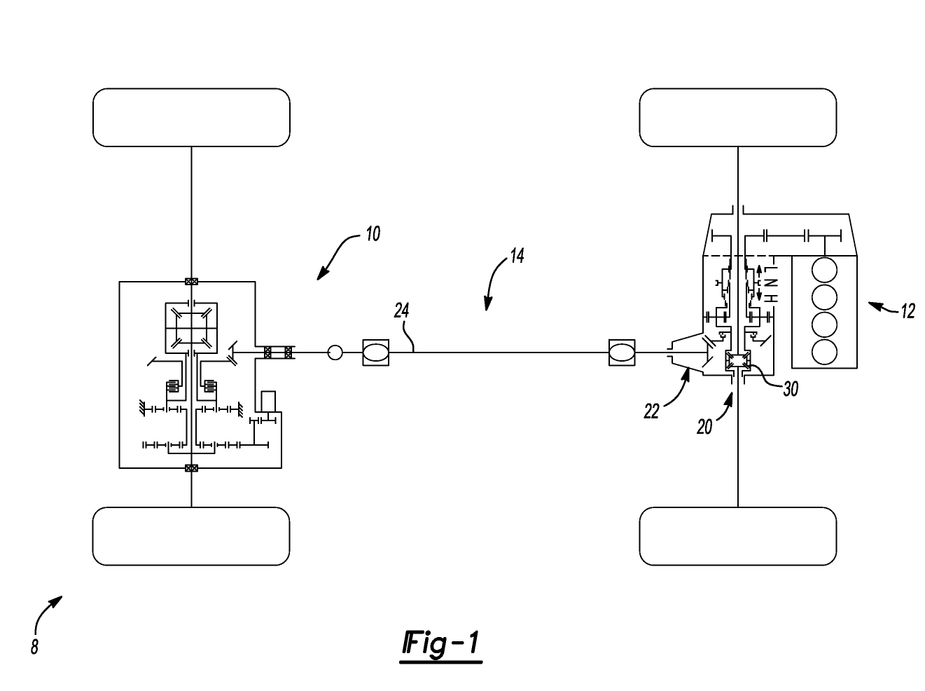

With reference to FIG. 1 of the drawings, an exemplary vehicle 8 is illustrated as including an exemplary driveline component 10 that is constructed in accordance with the teachings of the present disclosure. The vehicle 8 can otherwise be conventional in its construction and can include a power train 12 and a driveline 14. The power train 12 can include a source of propulsive power, such as an internal combustion engine and/or an electric motor, as well as any desired gearing (i.e., transmission), clutch and/or torque converter. The driveline 14 can include a primary axle 20, a power take-off unit (PTU) 22, a propshaft 24 and the driveline component 10, which constitutes a secondary axle in the particular example provided. The primary axle 20 can be permanently driven by the power train 12 and can conventionally include a differential assembly 30. The PTU 22 can be configured to transmit rotary power to the driveline component 10 via the propshaft 24. The PTU 22 can be configured to transmit rotary power on a full time basis, or could be configured to transmit rotary power on an as-needed/desired basis through the use of a clutch or other type of rotary coupling that can be selectively operated to permit or interrupt the transmission of rotary power.

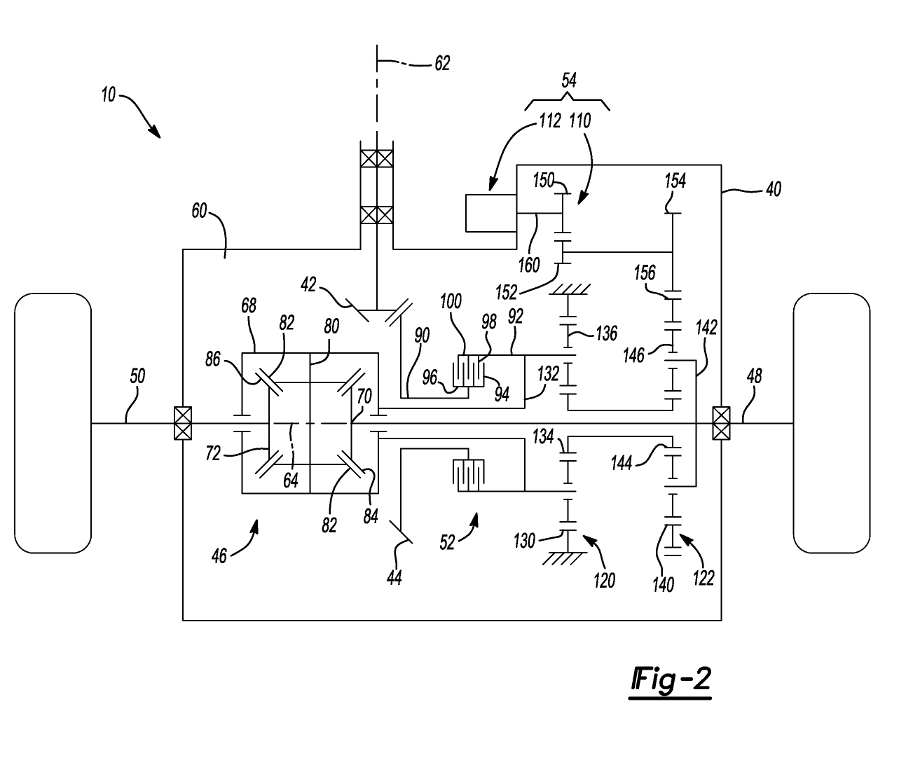

With reference to FIGS. 1 and 2, the driveline component 10 can include a housing 40, an input pinion 42, a ring gear 44, a differential assembly 46, first and second output shafts 48 and 50, respectively, a rotary coupling 52 and a torque-vectoring module 54. The housing 40 can define a cavity 60 into which the input pinion 42, the ring gear 44, the differential assembly 46 and the rotary coupling 52 can be received.

The input pinion 42 can be supported for rotation by the housing 40 about a first axis 62. The input pinion 42 can be coupled to the propshaft 24 for common rotation.

The ring gear 44 can be supported by the housing 40 for rotation about a second axis 64 that can be transverse to the first axis 62. The ring gear 44 can be meshingly engaged with the input pinion 42.

The differential assembly 46 can comprise a differential case 68, first and second differential output members 70 and 72, respectively, and a means for transmitting rotary power from the differential case 68 to the first and second differential output members 70 and 72 while permitting a speed differential between the first and second differential output members 70 and 72. The differential case 68 can be supported by the housing 40 for rotation about the second axis 64. The first and second differential output members 70 and 72 can be received in the differential case 68 and rotatably disposed about the second axis 64. The power transmitting means can be any type of mechanism that is known in the art, such as one or more clutches or differential gearing. In the particular example provided, the power transmitting means comprises differential gearing having a cross-pin 80, a plurality of bevel pinion gears 82 and first and second side gears 84 and 86, respectively. The cross-pin 80 can be fixedly mounted to the differential case 68 generally perpendicular to the second axis 64. The bevel pinion gears 82 can be rotatably received on the cross-pin 80 and disposed in the differential case 68. The first and second side gears 84 and 86 can be received in the differential case 68 and rotatably disposed about the second axis 64. Each of the first and second side gears 84 and 86 can be meshingly engaged with the bevel pinion gears 82 and can be coupled for rotation with a corresponding one of the first and second differential output members 70 and 72. In the particular example provided, each of the first and second differential output members 70 and 72 is co-formed with a corresponding one of the first and second differential output members 70 and 72.

The first and second output shafts 48 and 50 can be non-rotatably coupled with the first and second differential output members 70 and 72, respectively. In the example provided, the first and second differential output members 70 and 72 comprise internally splined or toothed portions (not specifically shown) of the first and second side gears 84 and 86, respectively, and matingly engage a male splined or toothed segment (not specifically shown) formed on an associated one of the first and second output shafts 48 and 50.

The rotary coupling 52 can have first and second portions 90 and 92, respectively, that are rotatably disposed about the second axis 64. The first portion 90 can be coupled to the ring gear 44 for common rotation, while the second portion 92 can be coupled to the differential case 68 for common rotation. The rotary coupling 52 can be any type of coupling or clutch that can be employed to selectively transmit rotary power between the ring gear 44 and the differential case 68. For example, the rotary coupling 52 can be a type of clutch that is capable of connecting the ring gear 44 to the differential case 68 when there is a rotational speed differential between the ring gear 44 and the differential case 68. In the particular example provided, the rotary coupling 52 comprises a friction clutch, the first portion 90 comprises a first set of clutch plates 94 and an inner clutch carrier 96, and the second portion 92 comprises a second set of clutch plates 98 and an outer clutch carrier 100. The first set of clutch plates 94 can be axially slidably but non-rotatably coupled to the inner clutch carrier 96 and the inner clutch carrier 96 can be coupled to the ring gear 44 for common rotation. The second set of clutch plates 98 can be interleaved with the first set of clutch plates 94 and axially slidably but non-rotatably coupled to the outer clutch carrier 100. The outer clutch carrier 100 can be non-rotatably coupled to the differential case 68.

The torque-vectoring module 54 can include a transmission 110 and an electric motor 112. The transmission 110 can have a first planetary gearset 120 and a second planetary gearset 122.

The first planetary gearset 120 can have a first planetary ring gear 130, a first planet carrier 132, a first sun gear 134 and a plurality of first planet gears 136. The first planetary ring gear 130 can be fixedly coupled to the housing 40 so that relative rotation between the first planetary ring gear 130 and the housing 40 is not permitted. The first planet carrier 132 can be coupled to the outer clutch carrier 100 of the second portion 92 of the rotary coupling 52 for common rotation. In the example provided, the outer clutch carrier 100 defines a portion of the first planet carrier 132. The first sun gear 134 can be disposed about the first output shaft 48. The first planet gears 136 can be rotatably supported by the first planet carrier 132 and can be meshingly engaged with both the first planetary ring gear 130 and the first sun gear 134.

The second planetary gearset 122 can have a second planetary ring gear 140, a second planet carrier 142, a second sun gear 144 and a plurality of second planet gears 146. The second planetary ring gear 140 can be rotatably disposed about the first output shaft 48. The second planet carrier 142 can be coupled to the first output shaft 48 for common rotation about the second axis 64. The second sun gear 144 can be disposed about the first output shaft 48 and can be coupled to the first sun gear 134 for common rotation about the second axis 64. The second planet gears 146 can be supported for rotation on the second planet carrier 142 and can be meshingly engaged with both the second planetary ring gear 140 and the second sun gear 144.

The electric motor 112 can be configured to selectively drive the transmission 110 and can be a type of reversible electric motor. In the particular example provided, the transmission 110 further includes a motor pinion 150, a first intermediate gear 152, a second intermediate gear 154 and a third intermediate gear 156. The motor pinion 150 can be coupled to an output shaft 160 of the electric motor 112 for common rotation and can be meshingly engaged with the first intermediate gear 152. The first and second intermediate gears 152 and 154 can be coupled to one another for common rotation. The third intermediate gear 156 can be coupled to the second planetary ring gear 140 for common rotation. In the particular example provided, the third intermediate gear 156 comprises teeth that are formed about the exterior circumference of the second planetary ring gear 140.

With reference to FIGS. 1 and 2, the driveline component 10 can be operated in a first or disconnected mode in which the rotary coupling 52 decouples the ring gear 44 from the differential case 68 to prevent the transmission of rotary power therebetween. In such situations, the vehicle 8 can be operated in a front-wheel drive mode to obtain improved fuel economy.

The driveline component 10 can be operated in a second or connected mode in which the rotary coupling couples the ring gear 44 to the differential case 68 to permit rotary power to be applied to the differential assembly 46. In such situations, the vehicle 8 is operated in an all-wheel drive mode that obtains increased traction over the front-wheel drive mode.

Regardless of the operational mode of the rotary coupling 52, the driveline component 10 may optionally be operated in a torque-vectoring mode (by operating the electric motor 112) to control the distribution of rotary power in a transverse direction across the differential assembly 46. Those of skill in the art will appreciate that operation of the electric motor 112 can drive the transmission 110 to generate a torque differential in which equal but opposite moments are superimposed onto the moments that are output to the first and second output shafts 48 and 50 via the differential assembly 46. The superimposed moments are sized and directed by the torque output by the electric motor 112 and the rotational direction of the electric motor 112, respectively, to aid in controlling the rear wheels of the vehicle 8.

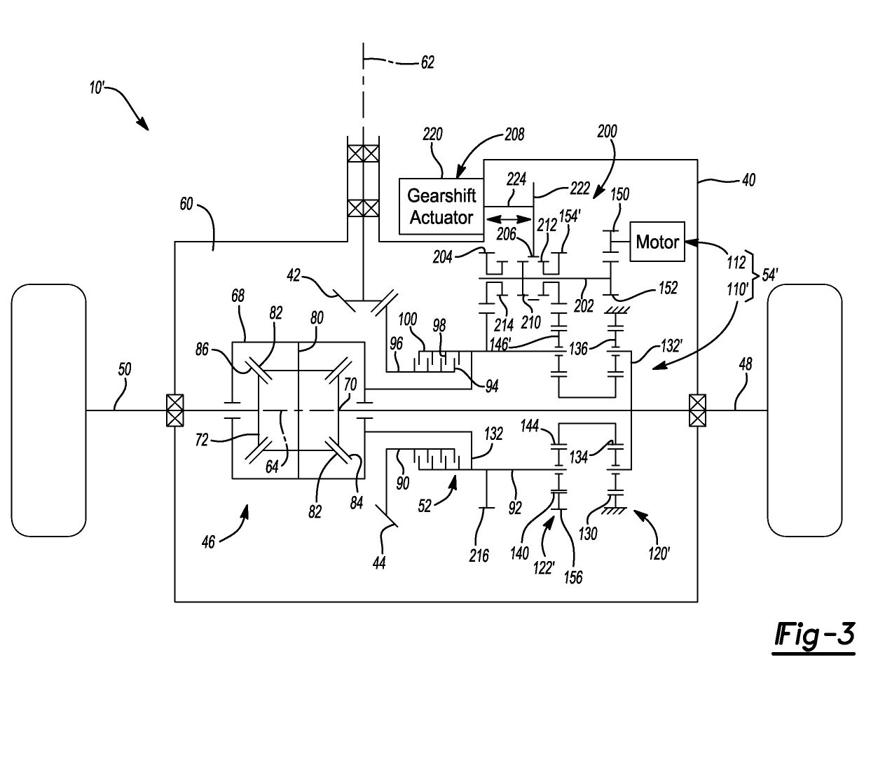

The example of FIG. 3 is generally similar to the example of FIGS. 1 and 2, except that the first planet carrier 132′ is drivingly coupled to the first output shaft 48 for common rotation, the second planet carrier 146′ is drivingly coupled to the second portion 92 of the rotary coupling 52, and a coupling 200 is employed to selectively operate the driveline component 10′ in a first or torque-vectoring mode, a second or neutral mode, and a third or propulsion mode.

The coupling 200 can include an input shaft 202, a first output gear 154′, a second output gear 204, a sleeve 206, which is movable along the rotary axis of the input shaft 202, and an actuator 208. The input shaft 202 can be coupled to the first intermediate gear 152 for rotation therewith. The input shaft 202 can include an output portion 210 having a plurality of male spline teeth that can be meshingly engaged to a plurality of female spline teeth that can be formed on the inside diameter of the sleeve 206. The first output gear 154′ can be rotatably mounted on the input shaft 202 and can be selectively coupled to the sleeve 206 for common rotation. In the particular example provided, the first output gear 154′ includes a plurality of male spline teeth 212 that can be matingly engaged to the female spline teeth formed on the sleeve 206. It will be appreciated, however, that other types of drive couplings can be employed to selectively transmit rotary power between the sleeve 206 and the first output gear 154′, such as face teeth or friction plates. The first output gear 154′ can be meshingly engaged to the third intermediate gear 156.

The second output gear 204 can be rotatably mounted on the input shaft 202 and can be selectively coupled to the sleeve 206 for common rotation. In the particular example provided, the second output gear 204 includes a plurality of male spline teeth 214 that can be matingly engaged to the female spline teeth formed on the sleeve 206. It will be appreciated, however, that other types of drive couplings can be employed to selectively transmit rotary power between the sleeve 206 and the first second gear 204′, such as face teeth or friction plates. The second output gear 204 can be meshingly engaged to a gear 216 that can be coupled to the second portion 92 of the rotary coupling 52 for common rotation.

The actuator 208 can be any type of actuator for selectively moving the sleeve 206 between a first position, in which the sleeve 206 is meshingly engaged with both the output portion 210 of the input shaft 202 and the male spline teeth 212 of the first output gear 154′, a second position, in which the sleeve 206 is meshingly engaged with the output portion 210 but is not engaged to either the male spline teeth 212 of the first output gear 154′ or the male spline teeth 214 of the second output gear 204, and a third position in which the sleeve 206 is meshingly engaged with both the output portion 210 and the male spline teeth 214 of the second output gear 204. In the particular example provided, the actuator 208 includes a linear motor 220 and a fork 222 that is fixedly coupled to an output 224 of the linear motor 220 and received in a slot (not specifically shown) formed about the sleeve 206.

When the actuator 208 is operated to position the sleeve 206 in a first position such that the coupling 200 operates in the first mode, rotary power provided by the motor 112 is output from the coupling 200 via the first output gear 154′ to provide an input to the ring gear 140 of the second planetary gearset 122′. The first and second planetary gearsets 120′ and 122′ can be employed to provide counter-directed moments via the first and second planet carriers 132′ and 142′, respectively, to the first and second output shafts 48 and 50, respectively.

When the actuator 208 is operated to position the sleeve 206 in a second position such that the coupling 200 operates in the second mode, the electric motor 112 is decoupled from both the second planetary gearset 122′ and the second portion 92 of the rotary coupling 52.

When the actuator 208 is operated to position the sleeve 206 in a third position such that the coupling 200 operates in the third mode, rotary power provided by the motor 112 is output from the coupling 200 via the second output gear 204 to provide an input to the second portion 92 of the rotary coupling 52. In situations where the rotary coupling 52 is in an operational state that permits torque transfer between the first and second portions 90 and 92 of the rotary coupling 54, the rotary power that is provided via the second portion 92 can be configured to supplement the level of rotary power that is provided by the to drive the differential case 68 via the input pinion 42.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A driveline component comprising:
a housing defining a cavity;
an input pinion received in the cavity and rotatable about a first axis;
a ring gear received in the cavity and rotatably disposed about a second axis, the ring gear being meshingly engaged with the input pinion;
a differential assembly having a differential case, a first differential output member and a second differential output member;
first and second output shafts that are drivingly coupled to the first and second differential output members, respectively;
a rotary coupling having first and second portions that are rotatably disposed about the second axis, the first portion being coupled to the ring gear for common rotation, the second portion being coupled to the differential case for common rotation, the rotary coupling being configured to selectively transmit rotary power between the ring gear and the differential case; and
a torque-vectoring module having a transmission with a first planetary gearset and a second planetary gearset, the first planetary gearset having a first planetary ring gear, a first planet carrier, a first sun gear and a plurality of first planet gears, the first planetary ring gear being fixedly coupled to the housing, the first planet carrier being rotatably coupled to one of the first output shaft and the second portion of the rotary coupling, the first sun gear being disposed about the first output shaft, the first planet gears being rotatably supported by the first planet carrier and being meshingly engaged with the first planetary ring gear and the first sun gear, the second planetary gearset having a second planetary ring gear, a second planet carrier, a second sun gear and a plurality of second planet gears, the second planetary ring gear being rotatably disposed about the first output shaft, the second planet carrier being rotatably coupled to the other one of the first output shaft and the second portion of the rotary coupling, the second sun gear being disposed about the first output shaft and being coupled to the first sun gear for common rotation about the second axis, the second planet gears being supported for rotation on the second planet carrier and meshingly engaged with the second planetary ring gear and the second sun gear.

2. The driveline component of claim 1, wherein the torque-vectoring module further comprises an electric motor that is selectively operable for driving the transmission.

3. The driveline component of claim 2, wherein the transmission further comprises a motor pinion, which is coupled to an output shaft of the electric motor, and at least one gear reduction that is driven by the motor pinion and outputs rotary power to the second planetary ring gear.

4. The driveline component of claim 2, wherein the electric motor is a reversible electric motor.

5. The driveline component of claim 1, wherein the differential assembly comprises a differential gearset.

6. The driveline component of claim 5, wherein the differential gearset comprises a plurality of bevel pinion gears that are meshingly engaged to a pair of side gears, each of the side gears being coupled for rotation with a corresponding one of the first and second differential output members.

7. The driveline component of claim 1, wherein the rotary coupling is a clutch that is capable of connecting the ring gear to the differential case when there is a rotational speed differential between the ring gear and the differential case.

8. The driveline component of claim 7, wherein the clutch is a friction clutch, wherein the first clutch portion comprises a first set of clutch plates and wherein the second clutch portion comprises a second set of clutch plates that are interleaved with the first set of clutch plates.

9. The driveline component of claim 8, wherein the first clutch portion comprises an inner clutch carrier and the second clutch portion comprises an outer clutch carrier.

10. The driveline component of claim 9, wherein the outer clutch carrier defines a portion of the first planet carrier.

11. The driveline component of claim 1, further comprising a coupling having an input member, a first coupling output and a second coupling output, the first coupling output being drivingly coupled to the second ring gear, the second coupling output being drivingly coupled to the second portion of the rotary coupling, the coupling being selectively operable in a first mode in which the input member is drivingly coupled to the first coupling output to provide an input to the transmission, the coupling also being selectively operable in a second mode in which the input member is drivingly coupled to the second coupling output to provide an input to the second portion of the rotary coupling.

12. The driveline component of claim 11, wherein the coupling further comprises a sleeve that is movable along an axis of the input member to between a first position, in which the sleeve drivingly couples the input member to the first coupling output, and a second position in which the sleeve drivingly couples the input member to the second coupling output.

13. The driveline component of claim 12, further comprising an electric motor for selectively driving the input member.

14. The driveline component of claim 13, wherein the coupling further comprises an actuator that is configured to selectively move the sleeve between the first and second positions.

15. The driveline component of claim 14, wherein the actuator comprises a linear motor.

16. The driveline component of claim 15, wherein the actuator further comprises a fork that is received in a groove in the sleeve, the fork being coupled to an output of the linear motor for translation therewith.

17. The driveline component of claim 12, wherein the sleeve is movable into a third position between the first and second positions, wherein both the first coupling output and the second coupling output are decoupled from the input member when the sleeve is in the third position.

18. The driveline component of claim 11, wherein the first coupling output and the second coupling output are gears.

19. A driveline component comprising:
a housing;
an input pinion received in the housing and rotatable about a first axis;
a ring gear received in the housing and rotatable about a second axis, the ring gear being meshingly engaged with the input pinion;
a differential assembly received in the housing and rotatable about the second axis, the differential assembly having a differential case, a first differential output and a second differential output;
a first axle shaft coupled to the first differential output for rotation therewith;
a first coupling for selectively coupling the differential case to the ring gear for common rotation, the first coupling having a first portion, which is coupled to the ring gear for common rotation, and a second portion that is coupled to the differential case for common rotation; and
a transmission having first and second planetary gearsets that are selectively operable to apply equal and oppositely directed moments to the second portion of the first coupling and the first axle shaft.

20. The driveline component of claim 19, further comprising a second coupling and an electric motor, the second coupling comprising an input shaft, a first coupling output and a second coupling output, wherein the coupling is operable in a first mode in which rotary power provided by the electric motor is output to the transmission, and wherein the coupling is operable in a second mode in which rotary power provided by the electric motor is output to the second portion of the first coupling.
